(19) United States
(12) Patent Application Publication
(10) Pub. No.: US 2008/0284162 A1
(43) Pub. Date: Nov. 20, 2008

(54) Pipe coupling

(76) Inventor: Joseph A. Piscitelli, Martinez, CA (US)

Correspondence Address: PETER JAMES TORMEY, 2017 ESPERANZA DRIVE, CONCORD, CA, 94519, US

(21) Appl. No.: 11/803,895

(22) Filed: May 16, 2007

(51) Int. Cl. F16L 21/06

(52) U.S. Cl. 285/236

(57) ABSTRACT

A clamping assembly for joining pipe comprising a clamping band formed with a first retaining area and a second retaining area, having an axial split forming a first and second edge and a first tab disposed along the first edge of the axial split and a second tab along the second edge of the axial split, a first worm gear clamp for securing the clamping band to a first pipe section, a second worm gear clamp for securing the clamping band to a second pipe section, and at least one bolt for securing the first tab to the second tab for providing a sealed coupling of the first tab to the second tab and the first edge to the second edge, wherein coupling the first tab to the second tab provides for a seal of the first edge and the second edge such that the pipe join is sealed.

### BACKGROUND

The present invention relates generally to a pipe coupling and clamping assembly and more particularly to a system and means for coupling two pipe ends together so to avoid leakage or for repairing a broken pipe.

Many end to end pipe coupling and clamping assemblies are known for joining rigid pipe to allow for flow from a first pipe to enter into a second pipe without leakage. For example, cast iron pipe employed for sewerage, sanitary and domestic plumbing requirements typically is clamped together with the pipe ends in a fluid-tight, sealed and aligned configuration. The couplings may be of a reliable metal and affixed through soldering or they may be flexible couplings constructed to allow for an adjustable clamp assembly to affix them to the pipe ends.

Such clamp assemblies as are known, comprise a clamping band of sheet material which is corrosion-free and carries an underlying flexible coupling positioned therein adapted to be held in tight sealing relationship spanning a joint between pipes. The relationship is maintained by tensioned band straps mounted on the clamping band over a slotted portion thereof overlying each of two aligned pipe ends to be joined.

Conventional means to join pipe ends together have a drawback in that the coupling needs to slip over the pipe ends to provide reliable sealing. This requires that a user clear and clean the ends of the pipes and misaligned them sufficiently to allow for placing the coupling over the pipe ends. The user next needs to realign the pipe ends before securing the coupling in place. As such, what is needed is an easier way to apply a coupling to pipe ends that still maintains leak-tight integrity of the join.

### SUMMARY

Disclosed herein is a clamping assembly for joining pipe comprising a clamping band of flexible plastic formed into a predetermined circumferential length having a first annular end and a second annular end with a first retaining area disposed near the first annular end and a second retaining area disposed near the second annular end, said clamping band having an axial split the length of the clamping band forming a first and second edge and a first tab of a predetermined height disposed along the first edge of the axial split in the region bordered by the first retaining area and the second retaining area, said first tab having at least one hole, and a second tab of a predetermined height disposed along the second edge of the axial split in the region bordered by the first retaining area and the second retaining area, said second tab having at least one hole, a first worm gear clamp circumferentially located about the first retaining area for securing the clamping band to a first pipe section, a second worm gear clamp circumferentially located about the second retaining area for securing the clamping band to a second pipe section, a first plate having at least one hole positioned along the first tab, a second plate having at least one hole positioned along the second tab, and at least one bolt for securing the first plate and the first tab to the second tab and the second plate for providing a sealed coupling of the first tab to the second tab and the first edge to the second edge, said bolt being secured with at least one nut, wherein sealably coupling the first tab to the second tab provides for a leak-fight seal of the first edge and the second edge such that the clamping assembly seals the pipe join.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates one embodiment of the current disclosure.

FIG. 2 illustrates a second embodiment according to the current disclosure.

FIG. 3 illustrates several means of effecting a seal along an axially split clamping band.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

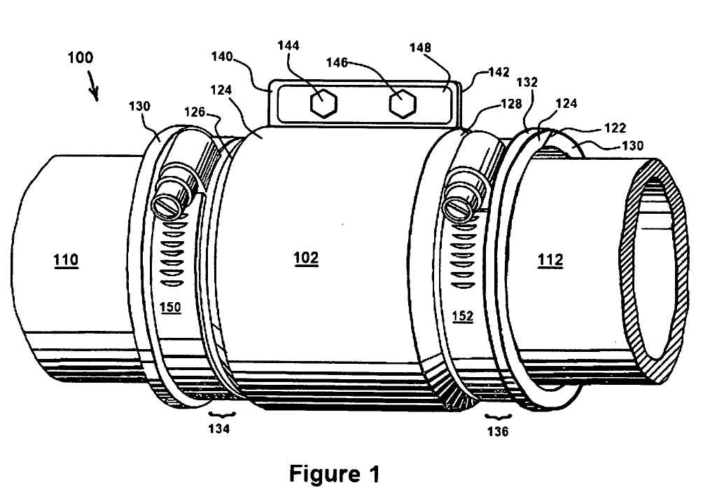

FIG. 1 illustrates one embodiment of the current disclosure 100. In the figure, a first pipe end 110 is axially aligned in an end-to-end relationship with a second pipe end 112. The first pipe end 110 and the second pipe end 112 are fitted into a clamping band 102 said clamping band 102 constructed of a flexible material and having a predetermined circumference and length. The clamping band 102 surrounds the joint between the first pipe end 110 and the second pipe end 112 for providing a sealed relationship thereupon.

The clamping band 102 has a central raised section 124 joined by sides 126 and 128. The sides 126 and 128 are complimented by a first and second wall 130 and 132 respectively, said walls displaced to allow for a first and second retaining area 134 and 136. The first retaining area 134 is formed between the first wall 130 and the first side 126 and the second retaining area 136 is formed between the second wall 132 and the second side 128. The clamping band 102 is split axially (122) along the entire length of the clamping band 102 to allow for wrapping the clamping band around one or more pipe ends or for placing around a portion of a single pipe without having to move the pipe ends 110 and 112.

The axial split 122 provides for an anterior edge 124 and a posterior edge 130. The clamping band 102 has a front tab 140 and a rear tab 142 disposed along the anterior edge 124 and the posterior edge 130 respectively. In the present embodiment the front tab 140 and the rear tab 142 are integrally formed of the same flexible material of the clamping band 102. The front tab 140 and the rear tab 142 each have one or more through holes (not shown) to allow for fasteners 144 and 146 to pass through and securably align the front tab 140 and the rear tab 142 sealably coupling the front tab 140 and the rear tab 142. In the figure, the front tab 140 has a front plate 148 for providing structural support and a more uniform sealing. The rear tab 142 has a similar rear plate (not shown). The front tab 140 and the rear tab 142 may be constructed of separate material or affixed differently to effectuate the same result.

In the FIG. 1, the anterior edge 124 and a posterior edge 130 are formed to provide a complimentary structure for providing a watertight or gastight seal along the axial split 122. The complimentary structure may be composed of portions having differing shapes to provide for sealing in different environments. A first worm gear clamp 150 is positioned in the first retaining area 134 and a second worm gear clamp 152 is positioned in the second retaining area 136. When secured the worm gear clamps 150 and 152 provide a seal about the first pipe end 110 and the second pipe end 112 respectively.

One having skill in the art will recognize that different clamps and fasteners may be used to effectuate a similar structure disclosed herein. Likewise the front plate 148 and the rear plate may be made form a variety of materials such as metals and plastics depending on the sealing requirements of the pipe join. Additionally, the clamping band 102 may be made from a variety of flexible materials including but not limited to rubber, plastic and elastomers. Common materials such as CI/Plastic provide for reliable operation and the inventor contemplates the current disclosure being formed from differing materials depending on the type of pipe, the material flowing through the pipe and the operating environment of the pipe.

The disclosed embodiment provides for a flexible coupling between two pipe ends or for placing over a ruptured pipe to maintain the leak-tight integrity of the join without requiring the pipe ends to be misaligned or a rubber coupling to be forced over the end of the pipe. Thus with the present disclosure one can repair a broken pipe without first severing the pipe, thus facilitating faster and more economical pipe repair and installation.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

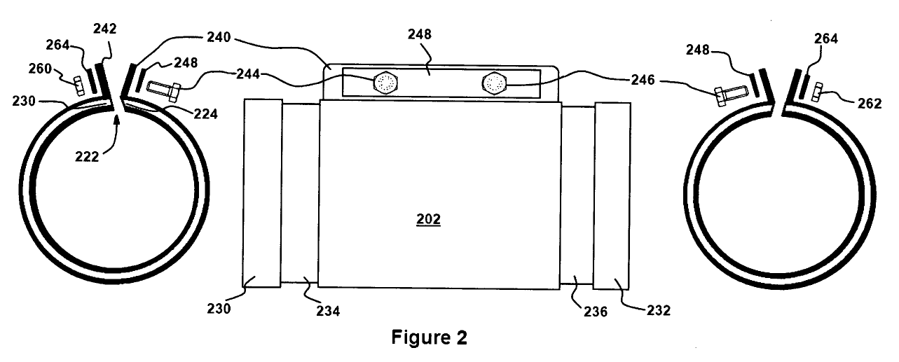

FIG. 2 illustrates a second embodiment according to the current disclosure. In the figure, a clamping band 202 is constructed of a flexible material and formed substantially annularly with an axial split 222 along the entire length of the clamping band 202. The axial split 222 provides for an anterior edge 224 and a posterior edge 230 running the length of the clamping band 202. The clamping band 202 is also formed to provide a first retaining area 234 disposed near a first end of the clamping band 202 and a second retaining area 236 disposed near a second end of the clamping band 202. The clamping band 202 is integrally formed with a front tab 240 along the anterior edge 224 in the region between the first retaining area 234 and the second retaining area 236. The clamping band 202 is also integrally formed with a rear tab 242 along the posterior edge 230 in the region between the first retaining area 234 and the second retaining area 236.

The figure shows a means of fastening the front tab 240 to the rear tab 242 using a bolt 244 and a nut 260 assembly as well as a second fastening means bolt 246 and nut 262. Secured between the bolt 244 and the front tab 240 is a front plate 248. The front plate 248 is also located between the second bolt 246 and the front tab 240. Secured between the nut 260 and the rear tab 242 is a rear plate 264. The rear plate 264 is also located between the second nut 262 and the rear tab 242. The front plate 248 and the rear plate 264 may be formed from one continuous piece of durable material such as a metal or hard plastic, or may be formed from a combination of pieces such that the fasteners provide a leak tight seal along the axial split 222.

One having skill in the art will recognized that, depending on the length of the coupling required, many through holes in the front tab 240 and rear tab 242 may be used to effectuate the current invention. Also differing fastening means may be employed to the same effect using such fasteners that are commonly employed in the art and their equivalents. Also the inventor contemplates combining the fasteners with all or parts of one of the plates. For example threading the rear plate such that the plate operates also as the nut portion of the fastener. Likewise the front plate 248 and the rear plate 264 may be constructed to clip on over the tabs using a spring type mechanism to support the plates and to provide a sealing means for the axial split 222.

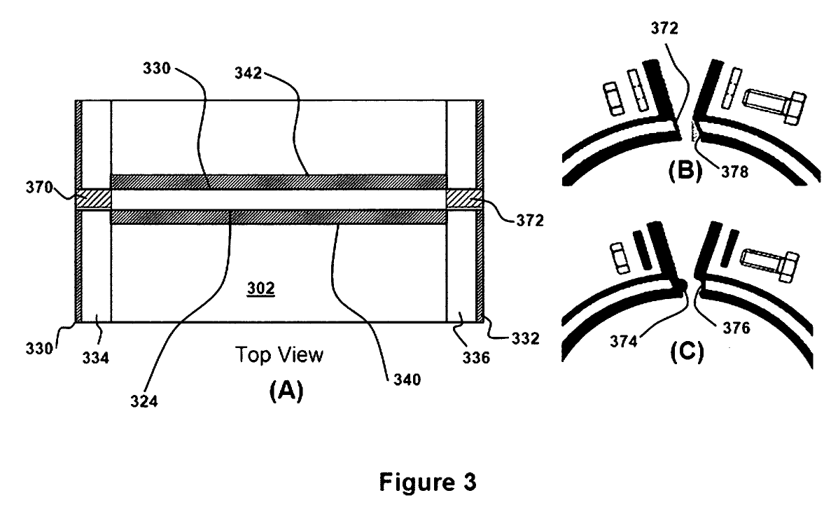

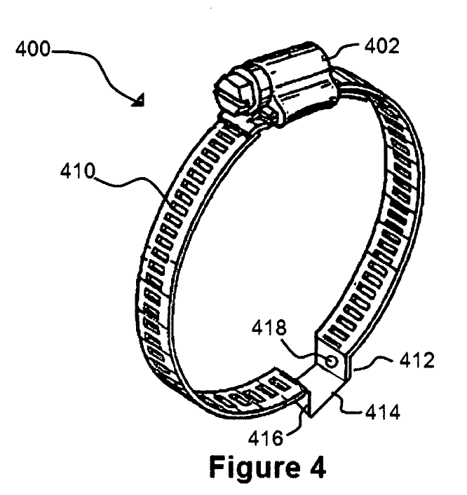

FIG. 3 illustrates several means of effecting a seal along an axially split clamping band. In FIG. 3(A) a clamping band 302 is constructed from flexible material to have a first retaining area 330 and a second retaining area 336 disposed on opposite ends of the clamping band 302. Each retaining area is offset from the ends of the clamping band by walls 330 and 332 respectively. The clamping band 302 is split axially along the length of the clamping band 302 to create an anterior edge 324 and a posterior edge 330. Integrally formed along the anterior edge 324 is a front tab 340 and integrally formed along the posterior wall 330 is a rear tab 342. The front tab 340 and the rear tab 342 are substantially located between the retaining areas 334 and 336.

In FIG. 3(A) the anterior edge 324 and the posterior edge 330 are irregularly formed to provide different means of sealing the edges together when operated. The area 370 is formed along the posterior edge 330 to provide a first angled shape complemented by a second angled shape 378. When in place, the first angled shape 370 mates with the second angled shape 378 to effectuate a seal as illustrated in FIG. 3(B). In FIG. 3(A), the angled shape does not extend the entire length of the posterior edge 330, but only in the region defined as the retaining areas 334 and 336 along with there associated walls 330 and 332 respectively.

FIG. 3(B) illustrates an alternative means of effectuating a seal between the anterior edge 324 and the posterior edge 330 using a tongue-in-groove structure. The posterior edge 330 is formed to have a protruding region 374 and the anterior edge 324 is formed to have a complementary region 376. When the posterior edge 330 and the anterior edge 324 are aligned during the operation of the current disclosure the protruding region 374 creates a seal by aligning with the complementary region 376. One having skill in the art will appreciate that the embodiments in FIG. 3 can be effectuated in many differing ways using alternative means than those disclosed.

The embodiments disclosed provide for a means to repair a broken pipe or to join pipe ends significantly easier than means currently available, also providing a reliable seal along the split ends of the coupling band in a way not previously produced. The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A clamping assembly for joining pipe comprising:
a clamping band of flexible material formed into a predetermined circumferential length having a first annular end and a second annular end with a first retaining area disposed near the first annular end and a second retaining area disposed near the second annular end, said clamping band having an axial split the length of the clamping band forming a first and second edge;
a first tab of a predetermined height disposed along the first edge of the axial split in the region bordered by the first retaining area and the second retaining area;
a second tab of a predetermined height disposed along the second edge of the axial split in the region bordered by the first retaining area and the second retaining area;
a first clamping means circumferentially located about the first retaining area for securing the clamping band to a first pipe section;
a second clamping means circumferentially located about the second retaining area for securing the clamping band to a second pipe section;
a fastening means for sealably coupling the first tab to the second tab,
wherein sealably coupling the first tab to the second tab provides for a leak-tight seal of the clamping assembly about the pipe join.

2. The clamping assembly of claim 1 wherein the first and second clamping means are flat band straps securely fastened.

3. The clamping assembly of claim 1 wherein the first and second clamping means are worm gear clamps.

4. The clamping assembly of claim 1 wherein the fastening means is a spring loaded clip.

5. The clamping assembly of claim 1 wherein the flexible material is selected form a group consisting of plastic, rubber, elastomer or CI/plastic.

6. The clamping assembly of claim 1 wherein the first edge and second edge are formed into complementary shapes such that the first edge and the second edge intercouple to effectuate a leak tight seal along the edge.

7. The clamping band of claim 1 wherein the first tab and the second tab are integrally formed with the clamping band.

8. The clamping band of claim 1 wherein the first tab and the second tab are fixedly disposed along the first edge and second edge respectively.

9. The clamping assembly of claim 1 wherein the first tab and the second tab have at least one hole each and the fastening means is one or more bolts secured with one or more nuts.

10. The clamping assembly of claim 9 further comprising at least one plate positioned along either the front, rear or both tabs and held in place by the fastening means.

11. The clamping assembly of claim 10 wherein the plate is made from metal.

12. The clamping assembly of claim 10 wherein the plate is made from plastic.

13. A clamping assembly for joining pipe comprising:
a clamping band of flexible plastic formed into a predetermined circumferential length having a first annular end and a second annular end with a first retaining area disposed near the first annular end and a second retaining area disposed near the second annular end, said clamping band having an axial split the length of the clamping band forming a first and second edge and a first tab of a predetermined height disposed along the first edge of the axial split in the region bordered by the first retaining area and the second retaining area, said first tab having at least one hole, and a second tab of a predetermined height disposed along the second edge of the axial split in the region bordered by the first retaining area and the second retaining area, said second tab having at least one hole;
a first worm gear clamp circumferentially located about the first retaining area for securing the clamping band to a first pipe section;
a second worm gear clamp circumferentially located about the second retaining area for securing the clamping band to a second pipe section;
a first plate having at least one hole positioned along the first tab;
a second plate having at least one hole positioned along the second tab;
at least one bolt for securing the first plate and the first tab to the second tab and the second plate thus providing a sealed coupling of the first tab to the second tab and the first edge to the second edge, said bolt being secured with at least one nut;
wherein sealably coupling the first tab to the second tab provides for a leak-tight seal of the first edge and the second edge such that the clamping assembly seals the pipe join.

14. The clamping assembly of claim 13 wherein the first edge and second edge are complementarily formed to effectuate a sealing relationship between the first and second edge.

15. The clamping assembly of claim 13 wherein the first edge is comprised of two or more portions of differing shapes.

16. A clamping assembly for joining pipe comprising:
a clamping band of flexible material formed into a predetermined circumferential length having a first annular end and a second annular end with a first retaining area disposed near the first annular end and a second retaining area disposed near the second annular end, said clamping band having an axial split the length of the clamping band forming a first and second edge, wherein said first edge and second edge are complementarily formed to effectuate a sealing relationship;
a first tab of a predetermined height integrally formed along the first edge of the axial split in the region bordered by the first retaining area and the second retaining area;
a second tab of a predetermined height integrally formed along the second edge of the axial split in the region bordered by the first retaining area and the second retaining area;
a first clamping means circumferentially located about the first retaining area for securing the clamping band to a first pipe section;
a second clamping means circumferentially located about the second retaining area for securing the clamping band to a second pipe section;
a fastening means for sealably coupling the first tab to the second tab,
wherein sealably coupling the first tab to the second tab provides for a leak-tight seal between the first edge and the second edge about the pipe join.

17. The clamping assembly of claim 17 wherein the flexible material is either plastic, rubber or CI/plastic or a combination thereof.

18. The clamping assembly of claim 17 wherein the first edge is comprised of two or more portions of differing shapes.

19. The clamping assembly of claim 17 wherein the first tab and the second tab have at least one hole each and the fastening means is one or more bolts secured with one or more nuts.

20. The clamping assembly of claim 19 further comprising:
at least one plate positioned along either the front, rear or both tabs and held in place by the fastening means and the one or more bolts pass through the at least one plate, the first tab and the second tab.
